(19) United States
(12) Patent Application Publication
(10) Pub. No.: US 2006/0084579 A1
(43) Pub. Date: Apr. 20, 2006

(54) Viscoelastic surfactant mixtures

(76) Inventors: Paul Daniel Berger, Sugar Land, TX (US); Christie Huimin Berger, Sugar Land, TX (US)

Correspondence Address: OIL CHEM TECHNOLOGIES;ATTN: PAUL BERGER, 13013 JESS PIRTLE BLVD., SUGAR LAND, TX, 77478, US

(21) Appl. No.: 11/249,604

(22) Filed: Oct. 13, 2005

Related U.S. Application Data
(60) Provisional application No. 60/619,337, filed on Oct. 15, 2004.

(51) Int. Cl. C09K 8/035; C09K 8/22

(52) U.S. Cl. 507/129

(57) ABSTRACT

A viscoelastic surfactant mixture (VESM) has been developed that is useful as a viscosity modifying additive for stimulating subterranean hydrocarbon containing formations. The VESM contains an amphoteric surfactant, an arylalkyl sulfonate cosurfactant and a polar solvent. The VESM may be employed as part of systems used in fracturing, acidizing, gravel packing and similar operations where a viscous fluid is required. The VESM can be applied over a wide range of temperatures and is especially useful if performance at elevated temperatures is required.

### CROSS-REFERENCE TO RELATED APPLICATIONS

This application claims the benefit of Provision Patent Application Ser. No. 60/619,337 filed by the present inventors.

### TECHNICAL FIELD OF THE INVENTION

The invention relates generally to the exploitation of hydrocarbon-containing formations. More specifically, the invention relates to fluids that are used to optimize and/or enhance the production of hydrocarbon from a formation (“well completion fluids”). Specifically this invent relates to Viscoelastic Surfactant Mixtures (VESM) useful in increasing the viscosity of certain fluids injected into subterranean oil reservoirs.

### BACKGROUND OF THE INVENTION

Hydrocarbons (oil, natural gas, etc.) are typically obtained from a subterranean geologic formation (i.e., a “reservoir”) by drilling a well that penetrates the hydrocarbon-bearing formation. In order for hydrocarbons to be “produced,” that is, travel from the formation to the wellbore (and ultimately to the surface), there must be a sufficiently unimpeded flowpath from the formation to the wellbore. This flowpath is through the formation rock, e.g., solid carbonates or sandstones having pores of sufficient size, connectivity, and number to provide a conduit for the hydrocarbon to move through the formation.

Recovery of hydrocarbons from a subterranean formation is known as “production.” One key parameter that influences the rate of production is the permeability of the formation along the flowpath that the hydrocarbon must travel to reach the wellbore. Sometimes, the formation rock has a naturally low permeability; other times, the permeability around the wellbore is reduced due to the damage caused by drilling the well. When a well is drilled, a drilling fluid is often circulated into the hole to contact the region of a drill bit, for a number of reasons such as: to cool the drill bit, to carry the rock cuttings away from the point of drilling, and to maintain a hydrostatic pressure on the formation wall to prevent production during drilling. During well operations, drilling fluid can be lost by leaking into the formation. To prevent this, the drilling fluid is often intentionally modified so that a small amount leaks off and forms a coating on the wellbore surface (often referred to as a “filtercake”). Once drilling is complete, and production is desired, this coating or filtercake must be removed.

Techniques used to increase the net permeability of the reservoir are referred to as “stimulation” techniques. Typically, stimulation techniques include methods such as: (1) injecting chemicals into the wellbore to react with and dissolve the damage (e.g., scales, filtercakes); (2) injecting chemicals through the wellbore and into the formation to react with and dissolve small portions of the formation to create alternative flowpaths for the hydrocarbon; and (3) injecting chemicals through the wellbore and into the formation at pressures sufficient to actually fracture the formation, thereby creating a large flow channel through which hydrocarbon can more readily move from the formation into the wellbore.

In particular, methods to enhance the productivity of hydrocarbon wells (e.g., oil wells) by removing (by dissolution) near-wellbore formation damage or by creating alternate flowpaths by fracturing and dissolving small portions of the formation at the fracture face are respectively known as “matrix acidizing,” and “acid fracturing.” Generally speaking, acids, or acid-based fluids, are useful in this regard due to their ability to dissolve both formation minerals (e.g., calcium carbonate) and contaminants (e.g., drilling fluid coating the wellbore or penetrated into the formation) introduced into the wellbore/formation during drilling or remedial operations.

Both the inhibition or removal of filtercakes and scales, and fluid placement are key concerns in well completion operations. Typical prior art techniques involve a multiple stage process. For example, in a typical prior art application, during completion operations, an acid treatment is performed, followed by a spacer. After this treatment, the well is cleaned, and a scale inhibitor is injected. A spacer is then injected, followed by a diverter. The process of additive (which may be an acid or a diverter, for example), spacer, additive, spacer, is repeated until all of the required treatments have been finished. This is a costly and time-consuming procedure.

Typically, matrix acidizing treatments have three major limitations: (1) limited radial penetration; (2) non-optimal axial distribution; and (3) corrosion of the pumping and well bore tubing. The first problem, limited radial penetration, occurs because once the acid is introduced into the formation (or wellbore), the acid reacts very quickly with the wellbore coating or formation matrix (e.g., sandstone or carbonate). In the case of treatments within the portion of the formation (rather than wellbore treatments), the formation near the wellbore that first contacts the acid is adequately treated. However, because most or all of the acid reacts upon contact, portions of the formation more distal to the wellbore (as one moves radially outward from the wellbore) remain untouched by the acid.

For instance, sandstone formations are often treated with a mixture of hydrofluoric and hydrochloric acids at very low injections rates (to avoid fracturing the formation). This acid mixture is often selected because it will dissolve clays (found in drilling mud) as well as the primary constituents of naturally occurring sandstones (e.g., silica, feldspar, and calcareous material). In fact, the dissolution is so rapid that the injected acid is essentially spent by the time it reaches a few inches beyond the wellbore. As a result, over 100 gallons of acid per foot is required to fill a region five feet from the wellbore (assuming 20% porosity and 6-inch wellbore diameter).

Similarly, in carbonate systems, the preferred acid is hydrochloric acid, which again, reacts so quickly with the limestone and dolomite rock that acid penetration is limited to between a few inches and a few feet. In fact, due to such limited penetration, it is believed matrix treatments are limited to bypassing near-wellbore flow restrictions—that is, they do not provide significant stimulation beyond what is achieved through (near-wellbore) damage removal. Yet damage at any point along the hydrocarbon flowpath can impede flow (hence production). Therefore, because of the prodigious fluid volumes required, these treatments are severely limited by their cost.

A second major problem that severely limits the effectiveness of matrix acidizing technology is non-optimal axial distribution. This problem relates to the proper placement of the acid-containing fluid—i.e., ensuring that it is delivered to the desired zone (that is, the zone that needs stimulation) rather than another zone.

More particularly, when a hydrocarbon-containing carbonate formation is injected with acid (e.g., hydrochloric acid), the acid begins to dissolve the carbonate. As acid is pumped into the formation, a dominant channel through the matrix is inevitably created. As additional acid is pumped into the formation, the acid naturally flows along that newly created channel—i.e., the path of least resistance—and, therefore, leaves the rest of the formation untreated. This, of course, is undesirable. It is exacerbated by intrinsic heterogeneity with respect to permeability (common in many formations)—this occurs to the greatest extent in natural fractures in the formation and due to high permeability streaks.

Again, these regions of heterogeneity in essence attract large amounts of the injected acid, hence keeping the acid from reaching other parts of the formation along the wellbore—where it is actually needed most. Thus, in many cases, a substantial fraction of the productive, oil-bearing intervals within the zone to be treated are not contacted by acid sufficient to penetrate deep enough (laterally in the case of a vertical wellbore) into the formation matrix to effectively increase its permeability and therefore its capacity for delivering oil to the wellbore.

The problem of proper placement is significant in these systems because the injected fluid preferentially migrates to higher permeability zones (the path of least resistance) rather than to the lower permeability zones—yet it is those latter zones, which require the acid treatment (i.e., because they are low permeability zones, the flow of hydrocarbon through them is restricted). In response to this problem, numerous, disparate techniques have evolved to achieve more controlled placement of the fluid—i.e., to divert the acid away from naturally high permeability zones and zones already treated and towards the regions of interest. A variety of prior art techniques (including emulsified acid systems, foamed systems, mechanical systems, and gelling agents) have been developed to control acid placement.

It has been difficult to find systems compatible over a wide range of temperatures with the wide variety of additives that are commonly used in well completion fluids that are suitable for inhibiting scale formation and can be properly, placed (i.e., self diverting).

Accordingly, what is desired are fluids that can inhibit the formation of scales and can be easily “spotted” or placed in the wellbore over the entire length of the desired zone. In addition, what is desired are fluids that are compatible with a wide range of additives over a broad range of temperatures and concentrations.

Viscous fluids play many important roles in oilfield service applications. The viscosity of the fluids allows them to carry particles from one region of the formation, the wellbore, or the surface equipment to another. For instance, one of the functions of a drilling fluid is to carry drilling cuttings from around the drilling bit out of the wellbore to the surface. Fluid viscosity also plays an essential role for instance in gravel packing placement. Gravel packing essentially consists of placing a gravel pack around the perimeter of a wellbore across the production zone to minimize sand production from highly permeable formations.

Viscoelastic fluids can also be used in hydraulic fracturing. Solid suspension properties are an important requirement for fracturing fluids. For a well to produce hydrocarbons from a subterranean geologic formation, the hydrocarbons have to follow a sufficiently unimpeded flow path from the reservoir to the wellbore. If the formation has relatively low permeability, either naturally or through formation damages resulting for example from addition of treatment fluids or the formation of scales as described above, it can be fractured to increase the permeability. Fracturing involves literally breaking a portion of the surrounding strata, by injecting a fluid directed at the face of the geologic formation, at pressures sufficient to initiate and/or extend a fracture in the formation. A fracturing fluid typically comprises a proppant, such as ceramic beads or sand to hold the fracture open after the pressure is released. It is therefore important for the fluid to be viscous enough to carry the proppant into the fracture.

The fluid viscosity is most commonly obtained by adding water-soluble polymers, such as polysaccharide derivatives. Recently, viscoelastic surfactants have been used as thickeners for example as described in U.S. Pat. Nos. 6,258,859, 6,435,277, 6,637,517, 6,667,280, 6,762,154, 6903,054 as well as published U.S. Patent Applications 2004/0214725, 2005/0003965, 2005/0124500, 2005/0209108, 2005/00379238, 2005/0067165, 2005/0124525. Also several recent patents have been involved in methods of breaking viscoelastic fluids such as described in U.S. Pat. No. 6,908,888. Unlike the polymers, viscoelastic surfactants based fluids do not lead to reduction of permeability due to solid deposits, and exhibit lower friction pressure. In addition, the viscosity of the fluid is reduced or lost upon exposure to formation fluids such as for instance crude oil thereby ensuring better fracture clean-up.

VESM are normally made by mixing in appropriate amounts suitable surfactants such as anionic, cationic, nonionic and zwitterionic surfactants. U.S. Pat. No. 4,375,421 discloses the use of Lonzaine C a coconut oil derived alkylamido betaine combined with anionic surfactants and in the presence of inorganic salts such as sodium chloride to form viscous liquids to ringing gels. U.S. Pat. No. 5,902,784 discloses the use of amphoteric surfactants in combination anionic surfactants to be used as drag-reducing agents. The viscosity of viscoelastic surfactant fluids, that is fluids containing VESM, is attributed to the three dimensional structure formed by the components in the fluids. When the concentration of surfactants in a viscoelastic fluid significantly exceeds a critical concentration, and in most cases in the presence of an electrolyte, surfactant molecules aggregate into species such as micelles, which can interact to form a network exhibiting elastic behavior.

Cationic viscoelastic surfactants—typically consisting of long-chain quaternary ammonium salts such as cetyltrimethylammonium bromide (CTAB)—have been so far of primarily commercial interest in wellbore fluid. Common reagents that generate viscoelasticity in the surfactant solutions are salts such as ammonium chloride, potassium chloride, sodium salicylate and sodium isocyanate and non-ionic organic molecules such as chloroform. The electrolyte content of surfactant solutions is also an important control on their viscoelastic behavior. Reference is made for example to U.S. Pat. Nos. 4,725,372, 5,964,295, and 5,979,557. However, fluids comprising this type of cationic viscoelastic surfactants usually tend to lose viscosity at high brine concentration (10 pounds per gallon or more). Therefore, these fluids have seen limited use as gravel-packing fluids or drilling fluids, or in other applications requiring heavy fluids to balance well pressure.

It is also known from International Patent Publication WO 98/56497, to impart viscoelastic properties using amphoteric/zwitterionic surfactants and an organic acid, salt and/or inorganic salt. The surfactants are for instance dihydroxyl alkyl glycinate, alkyl ampho acetate or propionate, alkyl betaine, alkyl amidopropyl betaine and alkylamino mono- or di-propionates derived from certain waxes, fats and oils. The surfactants are used in conjunction with an inorganic, water-soluble salt or organic additives such as phthalic acid, salicylic acid or their salts. Amphoteric/zwitterionic surfactants, in particular those comprising a betaine moiety are useful at temperature up to about 150° C. and are therefore of particular interest for medium to high temperature wells. However, like the cationic viscoelastic surfactants mentioned above, they are not compatible with high brine concentration.

### SUMMARY OF INVENTION

The present invention relates to VESM for use in treating a hydrocarbon-containing formation. The VESM is injected with injection fluid into a well, wherein the VESM includes about 1% to 99% by weight of one or more amphoteric viscoelastic surfactant(s) (VES) selected from a family of compounds defined by structure I below: 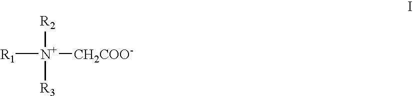
Where,

R₂ and R₃ are the same or different and preferably represent a low molecular weight alkyl residue, especially straight-chain alkyl residue with 1 to 4 carbon atoms, or hydroxy alkane; and R₁ is C12 to C30 linear or branch alkylene, preferably C16 to C24 or R₁ is structure II below: 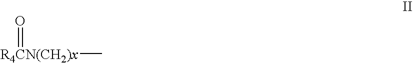
where R₄ is C12 to C30, preferably C16 to C24 linear or branched alkylene, and x is 2 to 6.

The VESM also includes from about 0.1% by weight to about 20% by weight of one or more cosurfactant(s) that is a member of the class arylalkyl sulfonates and is required for optimum performance. This cosurfactant is defined by structure III below: 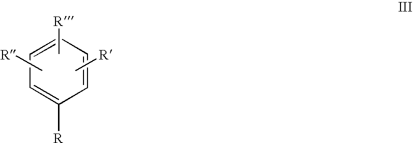
where:

R is none, branched or linear C1 to C30 alkyl, or an alkoxylate,

R′ is none, branched or linear C1 to C30 alky,

R″ is none, branched or linear C1 to C30 alkyl,

R′″ is a terminally sulfonated alkyl chain of 14 to 30 carbons in length having the structure:
CH₃(CH₂)nCH(CH₂)mSO₃M
where:

M is H, mono valent anion, divalent anion or amine.

Finally the VESM of the present invention contains one or more polar solvent(s). Suitable solvents include but are not restricted to water, C1-C6 linear or branched alcohol, ethylene glycol mono-butyl ether, glycerine, propylene glycol, ethylene glycol. The solvent is added to reduce the viscosity of the VESM but not interferer with the final viscosity enhancing properties of the VESM. In summary, the VESM of the present invention contains the following:
a) one or more amphoteric surfactant(s),
b) one or more co-surfactants of the class arylalkyl sulfonates, and
c) one or more polar solvent(s).
   The ratio of the amphoteric surfactant(s) to the cosurfactants is from about 50 to 1 to about 5 to 1 by weight and the solvent makes up the remainder of the VESM.

### BRIEF DESCRIPTION OF THE DRAWINGS

FIG. 1 shows the viscosities at various temperatures for two different viscoelastic surfactant mixtures in 300% CaCl₂ solutions.

### DETAILED DESCRIPTION

The composition of the present invention is designed to treat the hydrocarbon-containing formations. The composition of present invention is added to various injection fluids and imparts viscoelastic properties to these injection fluids with the advantage of providing superior viscosities and better economics than the prior art. The VESM of the present invention are relatively easy to place, are compatible with a broad range of additives, and function within a wide range of temperatures and salinities. Additives such as scale inhibitors, corrosion inhibitors, biocides that are known to the art can be employed along with the VESM when deemed necessary for their specific use.

One particular useful application of the present invention is in producing a fluid containing the VESM along with an acid. The combination of the VESM and the acid forms a viscoelastic diverting acid (VDA).

VDA is a term given to a class of compounds that exhibit reversible gelling behavior—that is, the fluid can be made to gel, then deliberately be un-gelled as needed. The ability to controllably gel and un-gel is important in fluid placement. Being able to gel, the VDA minimizes the axial distribution and radial penetration problems described above. Because the VDA forms a gel upon acid reaction with the formation, the VDA prevents additional, unneeded acid from entering the treated zones in the formation. U.S. Pat. No. 6,399,546 discusses VDA in detail.

Many mineral or organic acids (e.g., hydrochloric acid, hydrofluoric acid, sulfuric, phosphoric, formic, acetic, citric, maleic acids, and mixtures thereof) can be used with the VESM of the present invention to form VDA. Hydrofluoric acid is preferred for silicate formations and hydrochloric acid is preferred for carbonate formations. The VESM also contains one or more polar solvent(s), such as water, lower molecular weight alcohol(s), ether(s) and the like to enhance the handling and its viscosity building properties during its application in the formation.

The VESM of the present invention includes one or more amphoteric viscoelastic surfactant(s) from a family of compounds defined by structure I below: 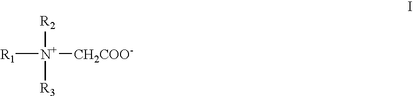
Where,

R₂ and R₃ are the same or different and preferably represent a low molecular weight alkyl residue, especially straight-chain alkyl residue with 1 to 4 carbon atoms, or hydroxy alkane; and

R₁ is C12 to C30 linear or branch alkyl or alkylene, preferably C16 to C24 or R₁ is structure II below: 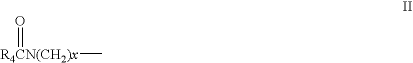
where R₄ is C12 to C30, preferably C16 to C24 linear or branched alkyl or alkylene, and x is 2 to 6.

The VESM also includes from about 0.1% by weight to about 20% by weight of one or more cosurfactant(s) that is a member of the class arylalkyl sulfonates and is required for optimum performance. This cosurfactant is defined by structure III below: 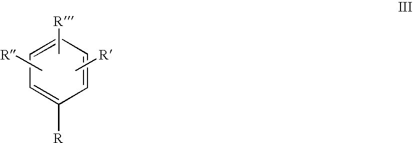
where:

R is none, branched or linear C1 to C30 alkyl or an alkoxylate

R′ is none, branched or linear C1 to C30 alkyl.

R″ is none, branched or linear C1 to C30 alkyl.

R′″ is a terminally sulfonated alkyl chain of 7 to 30 carbons in length having the structure: CH₃(CH₂)nCH(CH₂)mSO₃M where M is H, mono valent anion, divalent anion or amine.

Finally the VESM of the present invention contains one or more polar solvent(s). Suitable solvents include but are not restricted to water, C1-C6 linear or branched alcohol, ethylene glycol mono-butyl ether, glycerine, propylene glycol, ethylene glycol. The solvent is added to reduce the viscosity of the VESM but not interfere with the final viscosity enhancing properties of the VESM. Other ingredients such as biocides, scale inhibitors, corrosion inhibitors as known in the art can be added as needed.

The preferred examples of the VES are betaines called Mirataine BET-O-30™ and Mirataine BET-E-40™ from Rhodia, Inc. (Cranbury, N.J., U.S.A.). BET O-30™ contains an oleyl acid amide group (i.e., R₄ is a C₁₇H₃₃ alkene tail group in the above formula II) and is supplied as a solution having about 30% active surfactant; the remainder is substantially water, sodium chloride, and propylene glycol.

An analogous material, BET-E-40™, is also available from Rhodia and contains an erucic acid amide group (R₄ is a C₂₁H₄₁ alkene tail group in the above formula II), and is supplied as a solution having about 40% active ingredient, with the remainder substantially water, sodium chloride, and isopropanol. The structures of these two BET surfactants, and others, are described in U.S. Pat. No. 6,676,280. Chemical equivalents of these surfactants are available from several other suppliers and they can also be easily synthesized by methods known to those familiar with the art. Thus this invention is not limited to the use of BET surfactants exclusively and betaines sourced from other suppliers are equally as effective.

One or more arylalkyl sulfonate cosurfactant(s) is used in the present invention of the VESM as the cosurfactant to optimize the performance of the applications.

Both the VES and the co-surfactant may be used neat or premixed in the proper ratio prior to preparing the VDA. The ratio based on active ingredient is usually from about 5 to about 50 parts by weight of VES to about 1 part by weight of cosurfactant on a 100% active basis. Commercial samples of both the VES and the arylalkyl sulfonates cosurfactant are usually supplied as 30 or 50% by weight solutions in water or mixtures of water and glycols, glycol ethers, low carbon number alcohol solvent and the like. Particularly useful solvents are water, ethylene glycol monobutyl ether, propylene glycol, and glycerine either used alone or in combination. When solvents are employed, the appropriate concentration of active ingredient in the VDA is obtained by adjusting for the dilution effect of the solvent. Commercial samples of the VES also usually contain small amounts, up to about 8% sodium chloride that is a result of the process used to manufacture the VES. In most cases the salt does not interfere with the performance of the VES or the resulting VESM and therefore it does not have to be removed.

The VES is capable of forming structures such are micelles that are sheet-like, spherical, vesicular, or worm-like, this latter form being preferred. A most preferred zwitterionic surfactant comprises a betaine moiety and an oleic acid moiety, such as the previously mentioned surfactant BET-O-30. It should be noted that the oleic acid stock from which the oleic acid moiety is derived is generally about 75% pure to about 85% pure, and the balance of the stock comprises other fatty acids, such as linolenic acid, linoleic acid, etc. Some of these other fatty acids may be present in about 15% to about 25% of the total fatty acid moieties in the surfactant.

The VESM can be used for many other applications in addition to the matrix acidizing application described above. Other components can be included in the treating fluid along with the VESM, such as scale and corrosion inhibitors or biocides, depending on its intended use, formation conditions and other parameters readily apparent to one of ordinary skill in the art. For example, as a drilling fluid, the VESM is used along with other surface active agents, other viscosifiers such as polymers, filtration control agents such as Gilsonite and modified starches, density increasing agents such as powdered barites or hematite or calcium carbonate, or other wellbore fluid additives known to those skilled in the art.

As a gravel packing fluid, the VESM is preferably used along with gravel and other optional additives such as filter cake clean up reagents such as chelating agents, acids (e.g. hydrochloric, hydrofluoric, formic, acetic, citric acid), corrosion inhibitors, scale inhibitors, biocides, leak-off control agents, among others. For this application, suitable gravel or sand typically has a mesh size between 8 and 70 U.S. Standard Sieve Series mesh.

When used as part of a fracturing fluid, the VESM of this invention is used preferably with a proppant. Suitable proppants include, but are not limited to, sand, bauxite, glass beads, and ceramic beads. If sand is used, it will typically be from about 20 to about 100 U.S. Standard Mesh in size. Mixtures of suitable proppants can be used. The fracturing fluid can also comprise a proppant flowback inhibitor, for instance the proppant can be coated with a resin to allow consolidation of the proppant particles into a mass. The concentration of proppant in the fracturing fluid can be any concentration known in the art, and will typically be in the range of about 0.5 to about 20 pounds of proppant added per gallon of clean fluid.

### EXAMPLE 1

The following example is for illustrative purposes and compares the performance of a viscoelastic surfactant mixture in a 30% by weight Calcium Chloride (CaCl₂) solution. The 30% Calcium Chloride solution was chosen for the test because this is approximately the amount of Calcium Chloride that would be formed if a 15% by weight Hydrochloric Acid (HCl) was reacted with Calcium Carbonate (CaCO₃). In a typical acidizing project, a 15% HCl solution would be injected into the carbonate formation to be acidized along with the VESM. The acid would become spent by reaction with the Calcium Carbonate in the reservoir rock forming Calcium Chloride, water and carbon dioxide by the reaction shown below.
2HCl+CaCO_{3→}CaCl₂+CO₂+H₂O

Thus, this example simulates the reactions that take place down-hole during acidizing. This example compares the viscosity building characteristics of a VESM containing BET-0-30™ and two different cosurfactants. The first is sodium linear dodecylbenzene sulfonate (Na LABS), and is the preferred cosurfactant disclosed in U.S. Pat. No. 6,399,546. The second cosurfactant is the sodium salt of C14-16 arylalkyl xylene sulfonate (Na XSA-1416). The structure difference of the Na LABS and Na XSA-1416 are shown below.

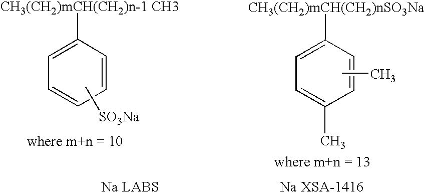

Without being bound any theory the inventors believe the difference in structure between the two surfactants accounts for the superior properties of VESM of the present invention containing the Na XSA-1416 cosurfactant. Note that the Na XSA-1416 has the sulfonate group attached to the end of the alkyl chain while the Na LABS has the sulfonate directly attached to the aromatic ring.

Two samples were prepared and compared to illustrate the superior temperature stability using the VESM of the present invention over the prior art.

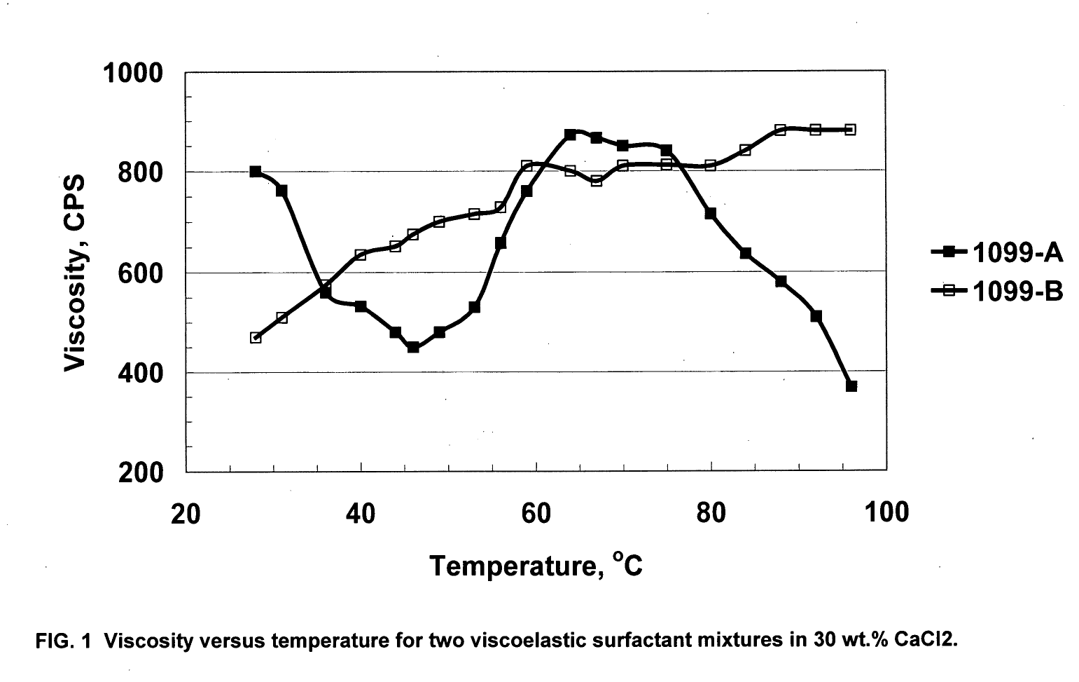

Testing Procedure:
1. Add 27 grams of BET-O-30 and 3.0 grams of a 30% aqueous solution of Na LABS to 270 gram sample of 30% by weight of CaCl₂ solution. This sample is designated as 1099A in the following discussion.
2. Add 27 grams of BET-O-30 and 3.0 grams of a 30% aqueous solution of Na XSA-1416 to 270 gram sample of 30% by weight of CaCl₂ solution. This sample is designated as 1099B in the following discussion.
3. The viscosities of the samples were measured at various temperatures using a Brookfield LVT viscometer, No. 3 Spindle at 60 rpm. The data is shown in FIG. 1.

As is shown in FIG. 1, the viscosity of the 1099A system provides higher viscosities only at temperatures less than 35° C. and between about 60° C. to 75° C.; whereas the viscosity of the 1099B yields high viscosities over a wide temperature range, which is very important for oil field applications. For example, the service companies can use one product to cover the wide temperature ranges experienced in filed applications and therefore reduce their inventory and cost. Furthermore, for fracturing applications, if the viscosity drops prior to reaching the bottom hole temperature this may cause the proppant to drop out of the gelled fluid and cause a “sand-out”. For temperatures higher than 60° C., the 1099A drops its viscosity rapidly while the 1099B maintains its viscosity.

The behavior of the VESM of the present invention containing the arylalkyl sulfonate cosurfactant is quite unexpected. It is unexpected that the viscosity should increase continuously over the temperature range as the temperature in increased. The superior viscosity building characteristics of VESM of the present invention containing arylalkyl sulfonate cosurfactants has been found to hold true for other applications such as fracturing fluids, gravel packing fluids, and drilling fluids This demonstrates the superior high temperature performance of the viscoelastic systems containing the VESM of this invention over the prior art.

1. A viscoelastic surfactant mixture for use in a hydrocarbon-containing formation comprising:
a) one or more amphoteric surfactants,
b) one or more arylalkyl sulfonate cosurfactants; and
c) one or more polar solvents.

2. The viscoelastic surfactant mixture described in claim 1 where the amphoteric surfactant is a betaine having the structure 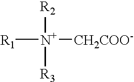
Where,
R₂ and R₃ are the same or different and preferably represent a low molecular weight alkyl residue, especially straight-chain alkyl residue with 1 to 4 carbon atoms, or hydroxy alkane; and R₁ is C12 to C30 linear or branch alkylene, preferably C16 to C24 or R₁ is structure II below 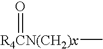
where R₄ is C12 to C30, preferably C16 to C24 linear or branched alkylene, and x is 2 to 6.

3. The viscoelastic surfactant mixture described in claim 1 where the arylalkyl sulfonate cosurfactant has the structure 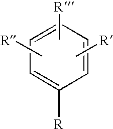
Where
R is none, branched or linear C1 to C30 alkyl, or an alkoxylate,
R′ is none, branched or linear C1 to C30 alkyl,
R″ is none, branched or linear C1 to C30 alkyl,
R′″ is a terminally sulfonated alkyl chain of 7 to 30 carbons in length having the structure: CH₃(CH₂)nCH(CH₂)mSO₃M where M is H, mono valent anion, divalent anion or amine.

4. The viscoelastic surfactant mixture described in claim 1 where the polar solvent is one or more selected from the group consisting of water, C1-C6 linear or branched alcohol, ethylene glycol mono-butyl ether, glycerine, propylene glycol, ethylene glycol.

5. The viscoelastic surfactant mixture described in claim 1 where the ratio of amphoteric surfactant to alkylaryl sulfonate cosurfactant is from about 50:1 to about 5:1, based on 100 percent active ingredients respectively.
